(19) United States
(12) Patent Application Publication
(10) Pub. No.: US 2008/0198628 A1
(43) Pub. Date: Aug. 21, 2008

(54) Night light type switch assembly

(75) Inventors: Ching-Huei Wu, San Chung City (TW); Yuan-Cheng Chin, San Chung City (TW)

Correspondence Address: TROXELL LAW OFFICE PLLC, SUITE 1404, 5205 LEESBURG PIKE, FALLS CHURCH, VA, 22041, US

(73) Assignee: Unity Opto Technology Co., Ltd.

(21) Appl. No.: 11/706,426

(22) Filed: Feb. 15, 2007

(51) Int. Cl. H01R 33/00

(52) U.S. Cl. 362/642

(57) ABSTRACT

The present invention relates to a night light type switch assembly, which comprises a base, a cover, a circuit board, a switch pushbutton, a sensor and at least one LED. The circuit board is mounted on the inside of the base, and electrically connected to the switch pushbutton. The circuit board is electrically connected to the sensor and the at least one LED to form a loop. The cover is located to cover the base.

### FIELD OF THE INVENTION

The present invention relates to a night light type switch assembly, and more particularly to a night light type switch assembly which has mounted therein a circuit board which electrically connects to a sensor and at least one LED to form a loop.

### BACKGROUND OF THE INVENTION

The night light commonly seen in the market is generally designed for insertion into the socket on the wall so as to enable the user to control the night light according to the environmental conditions or to enable the sensor mounted on the night light to switch on the night light automatically according to the surrounding brightness and shading value.

However, the above-mentioned night light is designed for independent use. Namely, the night light must have a plug mounted thereon. In addition, the socket must be mounted on wall for insertion thereinto of the night light so as to supply the electric power for the night light. For the purpose of inserting the night light, an unoccupied socket must be provided, causing a decrease in the amount of unoccupied socket.

Accordingly, according to the motive of the present invention, the present inventor makes diligent studies in providing consumers with a night light type switch assembly that combines a night light with a switch assembly to avoid the need to seek an additional power socket specially. In addition, the light source of the night light is the light-emitting diode so it not only provides lighting but also provides long lifetime and convenience of practice.

### SUMMARY OF THE INVENTION

It is a primary object of the present invention to provide a night light type switch assembly, which comprises a base, a cover, a circuit board, a switch pushbutton, a sensor and at least one LED. The circuit board is mounted on the inside of the base, and electrically connected to the switch pushbutton. The circuit board is electrically connected to the sensor and the at least one LED to form a loop. Accordingly, when the sensor detects that the surrounding brightness is insufficient, the at least one LED can provide lighting, thereby providing an increase in overall practicability.

It is a secondary object of the present invention to-provide a night light type switch assembly, wherein the at least one LED can be disposed on the circuit board inside or extendedly outside the base to increase overall practicability and convenience.

In order to achieve the foregoing objects, the present invention discloses a night light type switch assembly, which comprises a base, a cover, a circuit board, a switch pushbutton, a sensor and at least one LED. The circuit board is mounted on the inside of the base, and electrically connected to the switch pushbutton. The circuit board is electrically connected to the sensor and the at least one LED to form a loop. The cover is adaptable to cover the base.

The aforementioned and other objects and advantages of the present invention will be readily clarified in the description of the preferred embodiments and the enclosed drawings of the present invention.

### BRIEF DESCRIPTION OF THE DRAWINGS

FIG. 1 is a perspective view showing a first preferred embodiment of the present invention.

FIG. 2 is a decomposed view showing the devices in accordance with the first preferred embodiment the present invention.

FIG. 3 is a diagram showing the assembled structure in accordance with the first preferred embodiment of the present invention.

FIG. 4 is plan view showing the assembled structure in accordance with a second preferred embodiment of the present invention.

### DETAILED DESCRIPTION OF THE PREFERRED EMBODIMENT

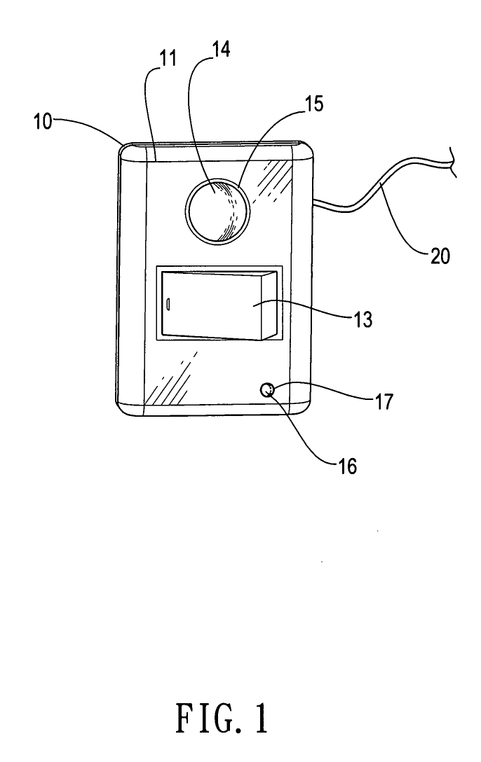

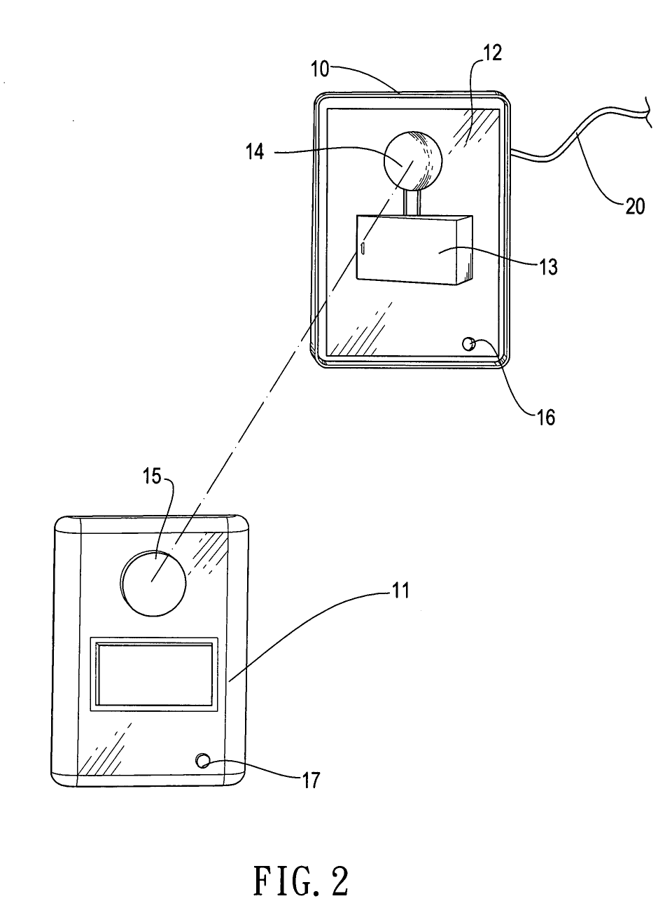

Referring to FIGS. 1 and 2, a night light type switch assembly of the present invention generally comprises a base 10, a cover 11, a circuit board 12, a switch pushbutton 13, a sensor 16 and at least one LED 14. The circuit board 12 is mounted on the inside of the base 10. The circuit board 12 is electrically connected to the switch pushbutton 13. The sensor 16 is electrically connected to the at least one LED 14. The cover 11 has a through hole 15 at a location corresponding to the at least one LED 14. In addition, the cover 11 has another through hole 17 at a location corresponding to the sensor 16. The cover 11 is located to cover the base 10 for thereby completing the night light type switch assembly.

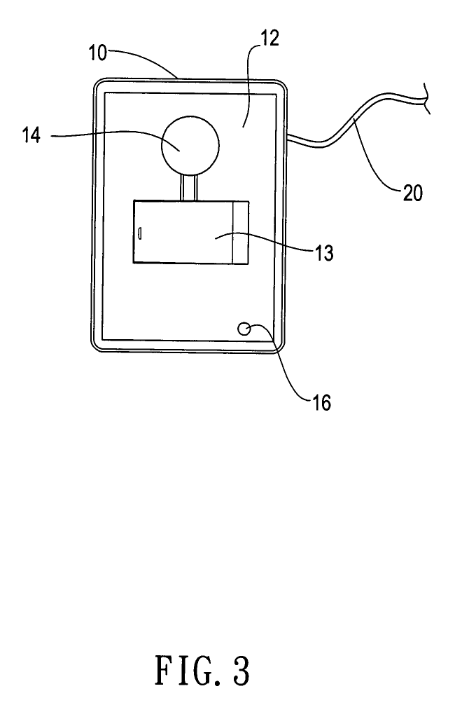

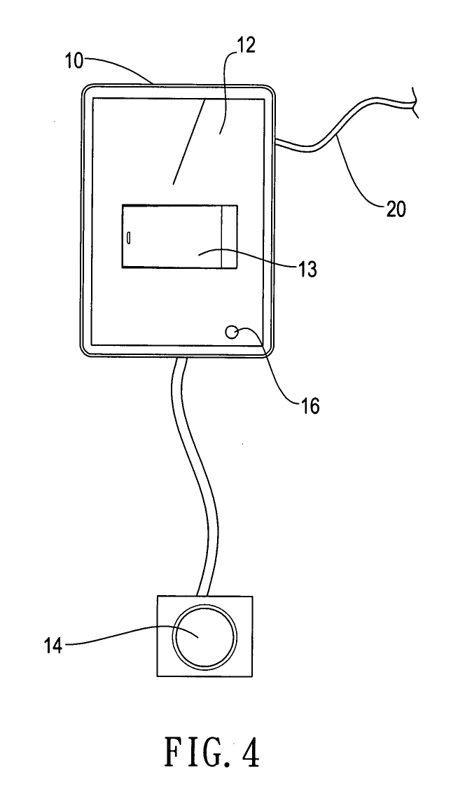

Referring to FIGS. 1 through 3, the present invention is featured in that the base 10, the cover 11, the circuit board 12, the switch pushbutton 13, the sensor 16 and the at least one LED 14 are assembled together. In addition, the circuit board 12 is mounted inside the base 10. The switch pushbutton 13 is electrically connected to the circuit board 12. The circuit board 12 is electrically connected to the sensor 16 and the least one LED 14 to form a loop. Accordingly, when the sensor 16 detects that the surrounding brightness is insufficient, the at least one LED 14 can provide the lighting to avoid the disposition of an additional set of night light and socket for thereby promoting the convenience of use and providing the good looks. Referring further to FIG. 4, during the use, the at least one LED 14 can be electrically connected to the circuit board 12, and then the at least one LED 14 can be extendedly disposed on the outside of the base 10, wherein the sensor 16 may be also mounted on the outside of the base 10 along with the at least one LED 14. Accordingly, the at least one LED 14 may be mounted at a location according to the requirement of users, thereby increasing the practicability and the convenience.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

To sum up, the night light type switch assembly of the present invention is capable of achieving the anticipated performance described above. Therefore, this application is filed according to the patent law.

What the invention claimed is:

1. A night light type switch assembly, comprising:
a base;
a cover adapted to cover said base;
a circuit board mounted inside said base;
a switch pushbutton;
a sensor; and
at least one LED, wherein said switch pushbutton is electrically connected to said circuit board, and said circuit board is electrically connected to said sensor and said at least one LED to form a loop.

2. A night light type switch assembly according to claim 1, wherein said at least one LED is mounted on said circuit board inside said base, and said cover has a through hole at a location corresponding to said at least one LED.

3. A night light type switch assembly according to claim 1, wherein said at least one LED is extendedly disposed on the outside of said base.

4. A night light type switch assembly according to claim 1, wherein said sensor is mounted on said circuit board inside said base, and said cover has a through hole at a location corresponding to said sensor.
